(19) United States
(12) Patent Application Publication
(10) Pub. No.: US 2025/0211662 A1
(43) Pub. Date: Jun. 26, 2025

(54) AIRBAG HOLDER

(71) Applicant: QINGZHI TANG, Wugang City (CN)

(72) Inventor: QINGZHI TANG, Wugang City (CN)

(21) Appl. No.: 18/946,957

(22) Filed: Nov. 14, 2024

(30) Foreign Application Priority Data
Dec. 21, 2023 (CN) 202323517373X

(51) Int. Cl. B60R 21/215; B60R 11/00; B60R 11/02

(52) U.S. Cl. CPC H04M 1/026; H04M 1/0279

(57) ABSTRACT

An airbag holder, including a base, an airbag body and a cover pressing part, where the base is arranged below the airbag body, the cover pressing part is arranged above the airbag body, and a plurality of sets of air holes are formed on the periphery of the airbag body; the base includes a bottom shell, a cover plate adapted to the bottom shell is installed below and attached to the bottom shell, a first fixing member is installed inside the bottom shell, and a snap fastener is arranged at the middle position of the upper surface of the first fixing member; the cover pressing part includes a second fixing member, a snap-fastener slot is formed at the middle position of the lower surface of the second fixing member, and the snap fastener is snapped into and butted with the snap-fastener slot.

### CROSS REFERENCE TO RELATED APPLICATION

This application claims priority benefit of Chinese patent application CN202323517373X, filed Dec 21, 2023. The content of the aforementioned application, including any intervening amendments thereto, are incorporated herein by reference.

### TECHNICAL FIELD

The present disclosure relates to the technical field of airbag brackets, and more particularly to an airbag holder.

### BACKGROUND

As consumers are increasingly dependent on mobile phones, mobile phone holders, as accessories, have become more and more popular. Currently, most of the mobile phone holders available on the market have complex structures, and the protruding parts thereof will reduce the user experience and are inconvenient for folding and use.

### SUMMARY

In order to overcome the above defects in the prior art, the present disclosure provides an airbag holder to solve the problems mentioned in the background art.

In order to achieve the above objective, the present disclosure provides airbag holder, including a base, an airbag body and a cover pressing part, where the base is arranged below the airbag body, the cover pressing part is arranged above the airbag body, and a plurality of sets of air holes are formed on the periphery of the airbag body;
the base includes a bottom shell, a cover plate adapted to the bottom shell is installed below and attached to the bottom shell, a first fixing member is installed inside the bottom shell, and a snap fastener is arranged at the middle position of the upper surface of the first fixing member; and
the cover pressing part includes a second fixing member, a surface cover is installed above and attached to the second fixing member, and a snap-fastener slot is formed at the middle position of the lower surface of the second fixing member.

As a further improved technical solution of the present disclosure, the snap fastener on the first fixing member is snapped into and butted with the snap-fastener slot on the second fixing member, and the first fixing member and the second fixing member are made of plastic material or metal material with a certain hardness.

As a further improved technical solution of the present disclosure, the airbag body is made of material with a certain flexibility and resilience.

As a further improved technical solution of the present disclosure, a magnet is embedded and installed on the lower surface of the first fixing member, the magnet has a segmented annular structure, and the magnet is adapted to the first fixing member.

As a further improved technical solution of the present disclosure, the airbag body is of an hourglass-like structure.

As a further improved technical solution of the present disclosure, the airbag body is snapped into and butted with the base and the cover pressing part.

The present disclosure has the beneficial technical effects and advantages:
the main design of the present disclosure is an airbag holder, and the airbag holder includes three parts: the base, the airbag body and the cover pressing part, where the plurality of sets of air holes are formed on the airbag body, and the airbag body is made of material with a certain flexibility and resilience, making the user more comfortable when using the holder;
the first fixing member and the second fixing member are made of material with a certain hardness to facilitate pressing operation; the airbag body is squeezed and deformed when the cover pressing part is pressed, and air inside the airbag body is discharged through the air holes, the snap fastener passes through the airbag body and is snapped into the corresponding snap-fastener slot, such that folding and fixation of the airbag holder are completed and the operation is very simple.

### BRIEF DESCRIPTION OF THE DRAWINGS

FIG. 1 is an overall structural schematic diagram of the present disclosure.

FIG. 2 is a structural schematic diagram of a bottom shell, a cover plate and a magnet in the present disclosure.

FIG. 3 is an explosive view of the present disclosure.

FIG. 4 is a structural schematic diagram of a base, an airbag body and a cover pressing part in the present disclosure.

FIG. 5 is a structural schematic diagram of a base, an airbag body and a cover pressing part in the present disclosure.

FIG. 6 is a structural schematic diagram of a second fixing member and a surface cover in the present disclosure.

Reference numerals in the drawings: 1. base; 2. airbag body; 3. cover pressing part; 4. air holes; 5. bottom shell; 6. cover plate; 7. first fixing member; 71. snap fastener; 8. magnet; 9. second fixing member; 91. snap-fastener slot; and 10. surface cover.

### DETAILED DESCRIPTIONS OF THE EMBODIMENTS

The technical solutions of embodiments of the present disclosure will be described below clearly and comprehensively in conjunction with accompanying drawings of the embodiments of the present disclosure. Apparently, the embodiments described are merely some embodiments rather than all embodiments of the present disclosure. All the other embodiments obtained by those of ordinary skill in the art based on the embodiments in the present disclosure without creative efforts shall fall within the scope of protection of the present disclosure.

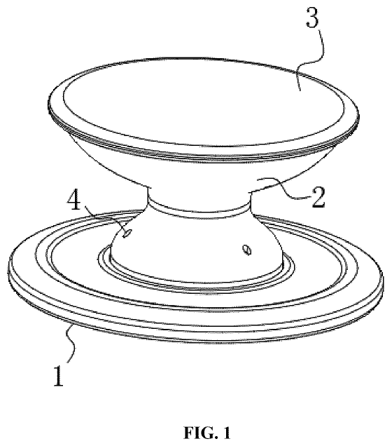

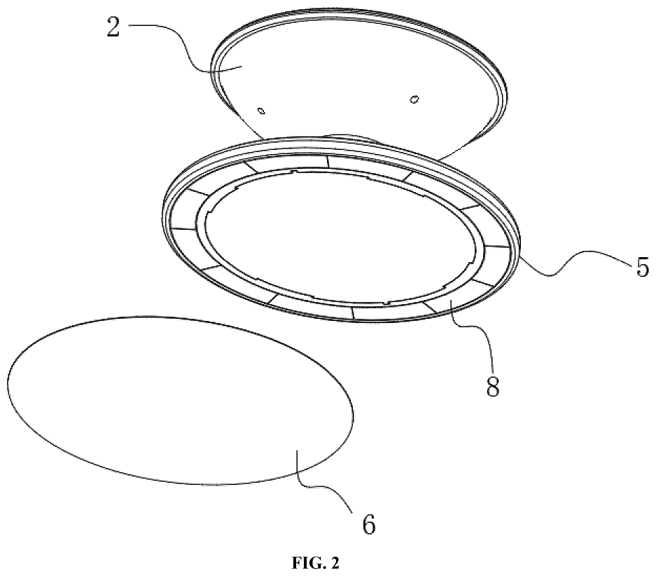

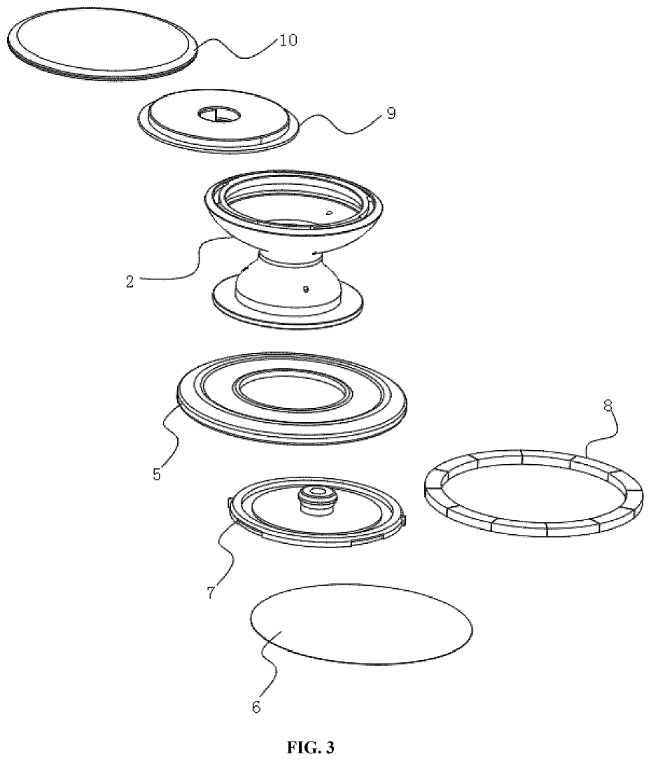

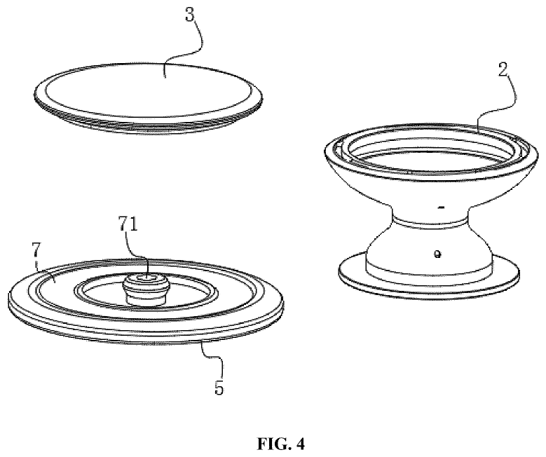

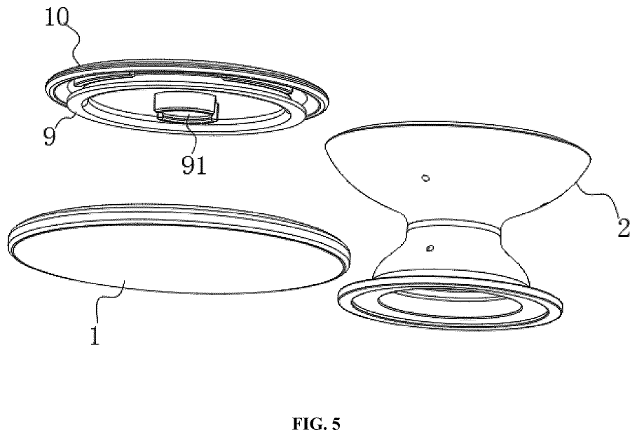

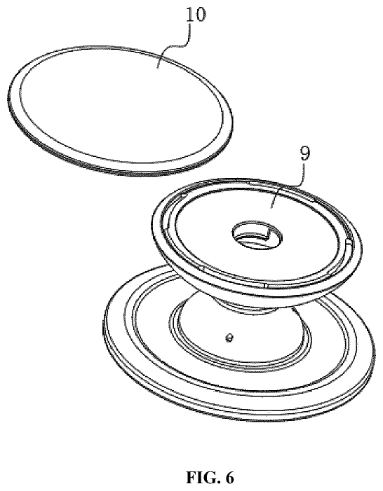

An airbag holder, as shown in FIGS. 1-6, including a base 1, an airbag body 2, a cover pressing part 3, air holes 4, a bottom shell 5, a cover plate 6, a first fixing member 7, a snap fastener 71, a magnet 8, a second fixing member 9, a snap-fastener slot 91 and a surface cover 10, where the base 1 is arranged below the airbag body 2, the cover pressing part 3 is arranged above the airbag body 2, and a plurality of sets of air holes 4 are formed on the periphery of the airbag body 2;
the base 1 includes the bottom shell 5, the cover plate 6 adapted to the bottom shell is installed below and attached to the bottom shell 5, the first fixing member 7 is installed inside the bottom shell 5, and the snap fastener 71 is arranged at the middle position of the upper surface of the first fixing member 7; and
the cover pressing part 3 includes the second fixing member 9, the surface cover 10 is installed above and attached to the second fixing member 9, and the snap-fastener slot 91 is formed at the middle position of the lower surface of the second fixing member 9.

Further, the snap fastener 71 on the first fixing member 7 is snapped into and butted with the snap-fastener slot 91 on the second fixing member 9, such the snap-fitting effect between them is utilized to facilitate overall folding and fixation of the holder.

Further, the first fixing member 7 and the second fixing member 9 are made of plastic material or metal material with a certain hardness, such that a certain hardness is provided to facilitate pressing by people.

Further, the airbag body 2 is made of material with a certain flexibility and resilience, the airbag body 2 is of an hourglass-like structure, and the airbag body 2 is snapped into and butted with the base I and the cover pressing part 3.

Further, the magnet 8 is embedded and installed on the lower surface of the first fixing member 7, the magnet 8 has a segmented annular structure, and the magnet 8 is adapted to the first fixing member 7, such that a complete annular magnet is formed by segmented magnet segments, thereby providing a certain magnetic attraction force for the entire holder.

Working principles of the present disclosure are as follows:
the main design of the present disclosure is an airbag holder. The airbag holder includes three parts: the base 1, the airbag body 2 and the cover pressing part 3, where the plurality of sets of air holes 4 are formed on the airbag body 2, and the airbag body 2 is made of material with a certain flexibility and resilience, making the user more comfortable when using the holder;
the first fixing member 7 is arranged inside the base 1, the second fixing member 9 is arranged inside the cover pressing part 3, the first fixing member 7 and the second fixing member 9 are made of material with a certain hardness to facilitate pressing operation; and the snap fastener 71 is arranged on the first fixing member 7, the snap-fastener slot 91 is formed on the second fixing member 9, the airbag body 2 is squeezed and deformed when the cover pressing part 3 is pressed, and air inside the airbag body 2 is discharged through the air holes 4, the airbag body 2 is a hollow structure with both ends penetrating each other, the snap fastener 71 passes through the airbag body 2 and is snapped into the corresponding snap-fastener slot 91, such that folding and fixation of the airbag holder are completed and the operation is very simple; and
further, the magnet 8 makes the entire holder have a certain magnetic attraction function and be attracted onto a back of a mobile phone, making it convenient for people for usage and fixation.

In the accompanying drawings of the embodiments disclosed in the present disclosure, only the structures related to the disclosed embodiments are provided, and other structures can refer to the usual design. Under the condition of having no conflict, the same embodiments and different embodiments of the present disclosure can be combined with one another.

The foregoing descriptions are merely exemplary embodiments of the present disclosure, and not intended to limit the present disclosure. Any modifications, equivalent substitutions, and improvements made within the spirit and principle of the present disclosure shall fall within the protection scope of the present disclosure.

What it claimed is:

1. An airbag holder, comprising a base, an airbag body and a cover pressing part, wherein the base is arranged below the airbag body, the cover pressing part is arranged above the airbag body, and a plurality of sets of air holes are formed on the periphery of the airbag body;
the base comprises a bottom shell, a cover plate adapted to the bottom shell is installed below and attached to the bottom shell, a first fixing member is installed inside the bottom shell, and a snap fastener is arranged at a middle position of an upper surface of the first fixing member; and
the cover pressing part comprises a second fixing member, a surface cover is installed above and attached to the second fixing member, and a snap-fastener slot is formed at a middle position of a lower surface of the second fixing member.

2. The airbag holder according to claim 1, wherein the snap fastener on the first fixing member is snapped into and butted with the snap-fastener slot on the second fixing member.

3. The airbag holder according to claim 2, wherein the first fixing member and the second fixing member are made of plastic material or metal material with a certain hardness.

4. The airbag holder according to claim 1, wherein the airbag body is made of material with a certain flexibility and resilience.

5. The airbag holder according to claim 1, wherein a magnet is embedded and installed on a lower surface of the first fixing member, the magnet has a segmented annular structure, and the magnet is adapted to the first fixing member.

6. The airbag holder according to claim 1, wherein the airbag body is of an hourglass-like structure.

7. The airbag holder according to claim 1, wherein the airbag body is snapped into and butted with the base and the cover pressing part.
